(19) United States
(12) Patent Application Publication
(10) Pub. No.: US 2024/0318542 A1
(43) Pub. Date: Sep. 26, 2024

(54) BOREHOLE DEPTH LOGGING

(71) Applicants: REFLEX INSTRUMENTS ASIA PACIFIC PTY LTD, Balcatta (AU); UNIVERSAL FIELD ROBOTS PTY LTD, Eagle Farm (AU)

(72) Inventors: John JACKSON, Balcatta (AU); Christopher Thomas KOPLAN, Balcatta (AU); Timothy Joseph CASSELL, Eagle Farm (AU)

(21) Appl. No.: 18/701,405

(22) PCT Filed: Oct. 14, 2022
(86) PCT No.: PCT/AU2022/051232

§ 371 Date: Apr. 15, 2024

(30) Foreign Application Priority Data
Oct. 14, 2021 (AU) 2021903305
Apr. 4, 2022 (AU) 2022900867

(51) Int. Cl. E21B 47/04; E21B 49/00; G01V 11/00

(52) U.S. Cl. CPC E21B 47/04; E21B 49/00; G01V 11/002

(57) ABSTRACT

A method for logging a borehole, comprising: receiving hole data representing the borehole, wherein the hole data includes at least a collar position indicating a location of the collar of the borehole; determining a measurement reference position indicating a reference location of a measurement device configured to be deployed into the borehole; receiving, from a depth logging device, one or more depth values of the measurement device in response to the deployment, from the reference location, of the measurement device to measure the borehole; and determining one or more corrected depth values based on the one or more depth values, the collar position, and the measurement reference position.

### TECHNICAL FIELD

The present invention relates to logging of a borehole, and specifically to improving depth values for geological measurements obtained post-drilling of the borehole.

### BACKGROUND

The term “borehole” is used to collectively refer to any of the various types of holes that may be drilled into a ground surface. Boreholes are created by a drilling process generally performed by a drill rig, for example in order to perform resource extraction or geotechnical investigation or assessment of an environmental site, such as a mine site, for example to enable the collection of soil samples, water samples or rock cores, or to install monitoring wells or piezometers.

Borehole measurement (or “logging”) systems obtain measurements of the geological physical parameters of the interior of a borehole via the use of a measurement device containing sensors, probes and/or other instrumentation components that are configured to obtain estimates of particular parameters. Depth measurement of a borehole is a particularly important function of a borehole logging system, in order for example, to determine the depth of the hole, or indications of the depths at which particular features of the borehole occur (e.g., the occurrence of mineral deposits).

Measurement data, including depth measurement values, may be obtained during the drilling of the borehole. This data may include directional-drilling measurements, e.g., for decision support for the wellbore path (generally referred to as “measurement while drilling” (MWD) data), and data related to the geological formations penetrated while drilling (generally referred to separately as “logging while drilling” (LWD) data). The various data that are obtained during the drilling of the borehole are referred to collectively as “hole drilling data” herein. There may also exist “hole pattern data” representing parameters specifying the desired properties for a borehole, and/or a pattern of boreholes, to be drilled into a particular surface. For example, the hole pattern data may be used to conduct drilling operations for one or more boreholes on the surface (i.e., leading to the subsequent generation of hole drilling data).

In addition, or as an alternative to relying on hole drilling data to profile the borehole, it is often desirable to obtain measurements from the borehole in its post-drilled state. This is referred to as a post-drilling measurement, or “hole logging”, and typically involves the insertion of a measurement device at least partially into the hole, and the transmission of the obtained data to instruments on or above the surface. The measurements obtained by the hole logging process provide additional information of the hole and its surrounding strata, that are unable to be measured at the time of drilling. Furthermore, it is desirable to compare the depth measurement data obtained post-drilling with those of the hole drilling data.

Borehole logging refers to the process by which post-drilling data (“hole logging data”) is collected from one or more holes after the drilling of the holes into a ground surface. It is desirable to log many holes over a particular surface in order to build up a model of the surface in terms of its properties. Specifically, this data enables a picture of the geology across the surface to be created in the form of a geological block model. The geological block model provides utility for assessing the surface and each individual borehole within, such as by assisting with increased efficiencies in planning and operating a mine site. For example, the existence of highly accurate and comprehensive hole logging data and/or in combination with other information obtained from for example MWD, LWD sources enables a more informed explosives loading plan to be created improving blast efficiencies and yields.

### SUMMARY

There is provided a method for logging a borehole, comprising: receiving hole data representing the borehole, wherein the hole data includes at least a collar position indicating a location of the collar of the borehole; determining a measurement reference position indicating a reference location of a measurement device configured to be deployed into the borehole; receiving, from a depth logging device, one or more depth values of the measurement device in response to the deployment, from the reference location, of the measurement device to measure the borehole; and determining one or more corrected depth values based on the one or more depth values, the collar position, and the measurement reference position.

In some embodiments, the one or more corrected depth values are corrected against a depth offset of the measurement reference position relative to the collar position.

In some embodiments, the depth offset is determined by determining a distance between the measurement reference position and the collar position, and the one or more corrected depth values are determined by applying the depth offset to each of the one or more depth values generated by the measurement device.

In some embodiments, the application of the depth offset is based on whether the measurement reference position is above the collar position or otherwise.

In some embodiments, the one or more corrected depth values are generated by incorporating the depth offset into the determination of one or more depths of the borehole.

In some embodiments, the measurement device is positioned at the reference location by a deployment vehicle, the deployment vehicle being positioned at a corresponding vehicle location at a surface region around the collar position.

In some embodiments, the deployment vehicle is an autonomous vehicle configured to guide itself to the vehicle location based on the hole data.

In some embodiments, the reference location of the measurement device is determined by the deployment vehicle based on the vehicle location.

In some embodiments, the reference location of the measurement device is determined by processing location data provided by a locator device within, or coupled to, at least one of: the deployment vehicle; and the measurement device.

In some embodiments, the measurement device is a geological logging tool configured to generate one or more geological measurement values of the borehole in response to the deployment of the measurement device to measure the borehole, the one or more geological measurement values corresponding to the one or more corrected depth values.

In some embodiments, in response to the measurement reference position being above the collar position, the generation of the one or more geological measurement values of the borehole and the one or more corrected depth values of the measurement device is delayed until the measurement device reaches the collar position of the borehole after the measurement device is deployed from the measurement position.

There is also provided a method for logging a borehole by a measurement apparatus, including: receiving a collar position of a borehole, wherein the collar position indicates a location of the collar of the borehole; determining a measurement reference position indicating a reference location from which a measurement device is to be deployed to measure the borehole; and generating, based on the collar position and the measurement position, one or more corrected depth values of the measurement device in response to the deployment, from the reference location, of the measurement device to measure the borehole.

There is also provided an apparatus for logging a borehole, including: a measurement device; a depth logging device; and a controller device having: a communications interface to receive data; at least one computer processor to execute program instructions; and a memory, coupled to the at least one computer processor, to store program instructions for execution by the at least one computer processor, wherein the measurement device is configured to: generate one or more geological measurement values of the borehole in response to the deployment of the measurement device into the borehole from the reference location; and transmit, to the controller device, the one or more geological measurement values; wherein the depth logging device is configured to: generate one or more depth values of the measurement device in response to the deployment, from the reference location, of the measurement device to measure the borehole; and transmit, to the controller device, the one or more depth values; and wherein the controller device is configured to: receive hole data representing the borehole, wherein the hole data includes at least a collar position indicating a position of the collar of the borehole; determine a measurement reference position indicating the reference location of the measurement device; and receive the one or more depth values from the depth logging device, and the one or more geological measurement values from the measurement device; determine one or more corrected depth values based on the one or more depth values, the collar position, and the measurement reference position.

There is also provided a borehole measurement apparatus comprising: a controller device configured to control operations of the borehole measurement apparatus associated with performing a logging of the borehole; a measurement device configured to generate one or more geological measurement values of the borehole in response to the deployment of the measurement device into the borehole from a reference location; and transmit the one or more geological measurement values to the controller device; and a depth logging device configured to: generate one or more depth values of the measurement device in response to the deployment, from the reference location, of the measurement device to measure the borehole; and transmit the one or more depth values to the controller device, wherein the borehole measurement apparatus is configured to communicate with a depth correction computing device external to the borehole measurement apparatus, the depth correction computing device having: a communications interface to receive data from at least the controller device; at least one computer processor to execute program instructions; and a memory, coupled to the at least one computer processor, to store program instructions for execution by the at least one computer processor, wherein the depth correction computing device is configured to: receive hole data representing the borehole, wherein the hole data includes at least a collar position indicating a position of the collar of the borehole; receive, via the communications interface, at least the one or more depth values generated by the depth logging device; and determine one or more corrected depth values based on the one or more depth values, the collar position, and a measurement reference position indicating the reference location of the measurement device.

In some embodiments, the depth correction computing device is configured to receive, via the communications interface, the measurement reference position.

In some embodiments, the controller device is configured to transmit the at least the one or more depth values generated by the depth logging device to the depth correction computing device according to a schedule.

In some embodiments, the measurement device is configured to provide the one or more geological measurement values to the depth correction computing device via the communications interface.

There is also provided a method for correcting depth values indicating a depth of a measurement device disposed within a borehole, comprising: receiving hole data representing the borehole, wherein the hole data includes at least a collar position indicating a location of the collar of the borehole; determining a measurement reference position indicating a reference location of the measurement device for measuring its depth within the borehole; receiving, from a depth logging device, one or more depth values of the measurement device within the borehole relative to the reference location; and adjusting each of the one or more depth values to correct for a difference between the collar position and the measurement reference position.

In some embodiments, adjusting each of the one or more depth values includes: determining a depth offset by determining a distance between the measurement reference position and the collar position; and applying the depth offset to adjust each of the one of more depth values, such that the adjustment of the one of more depth values accounts for whether the measurement reference position is above the collar position or otherwise.

In some embodiments, the measurement device is positioned at the reference location by a deployment vehicle, the deployment vehicle being an autonomous vehicle configured to guide itself to a vehicle location at a surface region around the collar position.

In some embodiments, the reference location of the measurement device is determined by the deployment vehicle based on the vehicle location.

In some embodiments, the reference location of the measurement device is determined by processing location data provided by a locator device within, or coupled to, at least one of: the deployment vehicle; and the measurement device.

There is also provided a method performed by a measurement apparatus for correcting depth values indicating a depth of a measurement device disposed within a borehole, the method comprising: receiving a collar position of a borehole, wherein the collar position indicates a location of the collar of the borehole; determining a measurement reference position indicating a reference location of the measurement device for measuring its depth within the borehole; and generating one or more adjusted depth values to correct for a difference between the collar position and the measurement reference position in respective depth measurements made by the measurement device within the borehole.

In some embodiments, generating the one or more adjusted depth values includes: determining a depth offset by determining a distance between the measurement reference position and the collar position; and applying the depth offset to adjust each of the one of more depth values, such that the adjustment of the one of more depth values accounts for whether the measurement reference position is above the collar position or otherwise.

In some embodiments, the measurement device is positioned at the reference location by a deployment vehicle, the deployment vehicle being an autonomous vehicle configured to guide itself to a vehicle location at a surface region around the collar position.

In some embodiments, the reference location of the measurement device is determined by the deployment vehicle based on the vehicle location.

In some embodiments, the reference location of the measurement device is determined by processing location data provided by a locator device within, or coupled to, at least one of: the deployment vehicle; and the measurement device.

There is also provided an apparatus for correcting depth values indicating a depth of a measurement device disposed within a borehole, including: the measurement device; a depth logging device; and a controller device having: a communications interface to receive data; at least one computer processor to execute program instructions; and a memory, coupled to the at least one computer processor, to store program instructions for execution by the at least one computer processor, wherein the measurement device is configured to: generate one or more geological measurement values of the borehole in response to the deployment of the measurement device into the borehole from a reference location; and transmit, to the controller device, the one or more geological measurement values; wherein the depth logging device is configured to: generate one or more depth values of the measurement device within the borehole relative to the reference location; and transmit, to the controller device, the one or more depth values; and wherein the controller device is configured to: receive hole data representing the borehole, wherein the hole data includes at least a collar position indicating a position of the collar of the borehole; determine a measurement reference position indicating the reference location of the measurement device from which the measurement device measures its depth within the borehole; receive the one or more depth values from the depth logging device, and the one or more geological measurement values from the measurement device; and adjust each of the one or more depth values to correct for a difference between the collar position and the measurement reference position.

### BRIEF DESCRIPTION OF DRAWINGS

Some embodiments are described herein below with reference to the accompanying drawings, wherein:

FIG. 1a illustrates a desired configuration of boreholes to be drilled in a surface of a site, in accordance with some embodiments;

FIG. 1b illustrates performing logging on one of the as drilled boreholes of FIG. 1a, in accordance with some embodiments;

FIG. 2 illustrates a block diagram of a measurement device, a deployment mechanism for deploying the measurement device to measure a borehole, and a controller device, in accordance with some embodiments;

FIG. 3 illustrates a flow diagram of a method for performing logging of the borehole, in accordance with some embodiments;

FIG. 4 illustrates a sub-process for determining the corrected depth values in the method of borehole logging of FIG. 3, in accordance with some embodiments;

FIG. 5a illustrates a first schematic diagram showing a first example for the determination of the depth offset values of the sub-process of FIG. 4, in accordance with some embodiments;

FIG. 5b illustrates a second schematic diagram showing a second example for the determination of the depth offset values of the sub-process of FIG. 4, in accordance with some embodiments;

FIG. 5c illustrates a third schematic diagram showing a third example for the determination of the depth offset values of the sub-process of FIG. 4, in accordance with some embodiments;

FIG. 6 illustrates a flow diagram of a method for performing logging of the borehole by a measurement device, in accordance with some embodiments; and

FIG. 7 illustrates a first graph of a set of post-drilling depth values logged for a borehole without depth correction; and

FIG. 8 illustrates a second graph of a set of post-drilling depth values logged for a borehole, in accordance with some embodiments.

### DESCRIPTION OF EMBODIMENTS

Borehole logging relies on the positioning of a measurement device relative to the mouth of the hole such as to enable the measurement data to be obtained. This is typically achieved via the use of a measurement (or “deployment”) vehicle that is configured for manual operation by site personnel. The vehicle is positioned in the vicinity of the borehole, and the personnel operate a deployment mechanism to physically align the measurement device with the borehole, usually based on ad-hoc and imprecisely specified (i.e., based on “eyeballing”) estimates performed by the personnel. Once the measurement device is considered to be aligned, the personnel manually deploy the measurement device into the borehole to perform the logging operation.

However, the drilling of the borehole typically results in a build-up of debris (referred to as “tailings”) on the ground surface of the region around the borehole collar. As a result there is generally an elevation or depression of the measurement vehicle from which the measurement device is mounted, causing a corresponding offset in the position of the measurement device, relative to a reference level of the borehole (i.e. the true ground level from which it is desired to measure the depth). Further, the debris build-up is often uneven across the ground surface around the borehole collar, resulting in variations to the offset depending on the exact location of the vehicle relative to the borehole. This leads to inaccurate depth values, and inconsistency in the depth values at which particular measurements are recorded depending on the pathing, and/or eventual location, of the vehicle in positioning the measurement device. Furthermore, any adjustment of the vehicle position and/or orientation that may be required to compensate for the inaccuracies introduced by the tailings dynamically vary based on the borehole, and even between instances of logging using the same measurement equipment. As a result, site personnel must perform different adjustments each time a given borehole is logged.

One approach to addressing the aforementioned drawback is to perform a ground transformation operation to flatten the surface region around the borehole collar, where the operation is performed post-drilling and prior to obtaining the measurements needed for hole logging. This may involve the use of ground levelling machinery, such as a front end loader vehicle, to remove or compact the borehole tailings surrounding the borehole collar.

However, additional steps must be taken to prevent the tailings from spilling into the borehole during the ground transformation operation. For example, a bladder may be placed into the hole to block residual tailings displaced during the ground levelling operation from travelling through to the bottom of the hole (i.e., to avoid the hole being filled up). The residual tailings and the bladder must then be removed to enable the measurement device to measure the depth and other geological parameters. This is time consuming and costly, and therefore acts as a barrier to the efficient logging of multiple holes consecutively across the surface.

Further, since at least part of the ground transformation operation must be performed manually, the conventional borehole logging process still cannot be performed in an autonomous manner. It is desired to develop an apparatus and methods that address one or more of these problems, or that at least provide a useful alternative.

### Overview

Described herein are embodiments of devices, apparatus, and methods for performing improved logging of a borehole 101 by improving the accuracy of depth values for geological measurements obtained from a measurement device 104 post-drilling of the borehole 101, using hole drilling data obtained from a drilling device 142 during drilling of the borehole 101. The depth measurements are corrected against an offset in the reference position of the measurement device 104 from which measurements are taken, relative to the position of the collar of the borehole 101.

It will be apparent to the skilled addressee that geological measurements include, but are not limited to, any one, or a combination of any two or more of the following: gamma radiation emitted by material in the hole, density of material in the hole, reflectivity of electromagnetic radiation, reflectivity of acoustic or ultrasonic waves, magnetic susceptibility of material in the hole, electrical resistivity/conductivity/impedance of material in the hole, magnetic vector field, hole dip, hole wall temperature, sonic velocity, contact hardness, hole azimuth, hole diameter, hole profile, hole volume and/or water level.

Generally disclosed are embodiments of a method for logging a borehole by a measurement apparatus, including: i) receiving hole data including at least an indication of a position of the borehole 101 on a surface 110; ii) determining a measurement reference position indicating a reference location from which a measurement device or component 104 is to be deployed to measure the borehole 101 (i.e., to “log” the borehole 101); and iii) generating, based on the collar position and the measurement reference position, one or more corrected depth values of the measurement device in response to the deployment, from the reference location, of the measurement device to measure the borehole 101. The measurement apparatus, and/or device 104, may include one or more computer systems, devices, or components configured to execute computer-implemented instructions to perform the method steps (i)-(iii) and described herein below.

Throughout the specification, the terms “logging a borehole” and “borehole logging” refer to the generalized activity of recording data for the borehole. That is, these terms are not intended to be taken as a specific reference to the process of generating depth measurements of a borehole by a measurement device during a corresponding conventional depthing process. This type of conventional approach to depth determination involves recording an initial position or location of the measurement device, moving the device through the hole, and then calculating the depth of the hole based on changes in position between the initial position or location and the current location of the device (i.e., during the movement of the device through the hole).

By contrast, the embodiments described herein perform a correction of the self-measured depth values obtained by a measurement device disposed within the borehole, by adjusting the depth values to account for a difference between collar and measurement reference positions. This enables the “logging” of the borehole with depth values that are corrected (or “adjusted”) for the discrepancy between the positions, rather than the depth values otherwise produced by the measurement device to measure its depth within the borehole (which are generated relative to an uncorrected reference). The proposed method thereby provides an advantage over the conventional approaches which cannot account for such a difference in collar and measurement reference positions.

An exemplary practical use of the proposed approach is to enable the adjustment of depth values that are obtained post drilling of the borehole values, such that these values may be aligned with corresponding depth values determined during drilling of the borehole (e.g., to promote improved accuracy in data analysis activities performed with the two corresponding data sets).

In one embodiment, a controller device 112 receives the hole drilling data generated by the drilling device 142, and the depth values. The controller 112 determines a measurement reference position (also referred to as a “measurement position”) M of the measurement device 104 from which measurement is performed, and processes the depth values associated with the measurement device 104 (i.e., as generated during measurement of the borehole 101) to produce corrected depth values.

That is, the controller device 112 is configured to adjust the depth values of the borehole logging measurements in a depth post-processing operation after the measurement device 104 has logged the borehole 101 (and provided the measurement data to the device 112). In another embodiment, the controller 112 can determine a depth correction value before the measurement device 104 starts logging to associate the measured parameter data with pre-corrected depth values.

In some aspects, the depth values are generated by a depth logging device 117 included as part of a deployment mechanism 109 configured to deploy, from the measurement reference position, the measurement device 104 to measure the borehole 101. The depth logging device 117 may be implemented as an electronic counter, or similar, circuit configured to measure an extension of the measurement device beyond its measurement position (e.g., by determining an amount of wireline).

In another embodiment, the measurement device 104 receives an indication of the collar position A of the borehole 101, and determines the measurement position M to measure depths of the borehole 101. The measurement device 104 generates corrected depth measurement values using the collar position A and the measurement position M. That is, the measurement device 104 may determine an amount of depth error inherent in initially generated depth values to produce the correction (i.e., via receipt of the initial depth values from the depth logging device 117 of the deployment mechanism 109) and may generate the corrected depth values directly in real-time (e.g., by accounting for the depth error in the obtained measurements).

In the described embodiments, the corrected depths may eliminate errors resulting from an offset in the measurement reference position M from the corresponding position A of the borehole 101. A depth offset value is determined by calculating a geospatial distance between the measurement M and collar A positions of the borehole 101. The geospatial distance value may be determined by any method of calculating a distance between two points in space. In some embodiments, the distance calculation method is selected in accordance with the positional coordinate system used to represent the measurement M and collar A positions of the borehole 101 (e.g., Euclidean distances for Cartesian coordinate based position representations, as described below). In some embodiments, the measurement and/or collar positions are determined as absolute location values directly indicating respective reference locations of the measurement device and/or borehole collar. The absolute location values may be, for example, Global Positioning System (GPS) co-ordinate values, location values from total station surveying techniques, or location values produced by other known techniques.

In some embodiments, determining a reference position of the measurement device (or borehole collar) includes converting an absolute location, for example as specified by GPS latitude and longitude values, to a value representing the measurement device or collar on the surface 110. The reference position may therefore indicate the corresponding reference location of the measurement device (or borehole collar) in a coordinate representation that facilitates depth offset calculations. For example, a Universal Transverse Mercator (UTM) conversion may be applied to convert GPS latitude and longitude values of a location on the curved surface of the Earth to flattened (i.e., planar) Cartesian UTM coordinate values for comparison to like values defined over the site 100. That is, the offset value may be calculated based on the 3D Cartesian co-ordinate values of the measurement M and borehole collar A positions. In some examples, the Cartesian UTM coordinate positions are obtained by applying UTM conversion to other non-GPS coordinate values, such as those of a site-specific coordinate system (e.g., Cartesian grid coordinate values). The measurement position M may be determined by processing location data obtained from a locator device, such as a GPS receiver within or coupled to the measurement device 104, or a vehicle 106 configured to deploy the measurement device 104 into the borehole 101.

In the described embodiments, the depth values are relative to a hole 107 of the borehole 101, such as to provide an indication of the wireline length of the borehole 101 irrespective of the orientation of the hole 107. That is, the depth measurements indicate a relative (or “measured”) depth as opposed to the true vertical depth of the borehole 101, being the vertical depth from the ground level. In other embodiments, the measurements are true depth values, and the depth offset is determined as the normal distance from the measurement reference position M to a reference plane containing the collar position A.

The generation of corrected depth values enables the logging of the borehole 101 with improved accuracy and without requiring a physical transformation of the surface 110 in a region 108 around the borehole collar. That is, the method eliminates errors in the depth values produced by the measurement device 104 resulting from the tailings or other obstacles surrounding the bore hole and/or the collar of the borehole without the need to perform a manual flattening operation of the ground at the surface region 108. The described devices, apparatus, and methods thereby improve the efficiency of, and the ability to achieve full automation in conducting, the drilling and post-drill logging operations for the borehole 101.

Furthermore, the measurement device is typically a geological logging tool configured to generate one or more geological measurement values of the borehole 101 in response to its deployment. Accordingly, the correction of the depth values facilitates the ability to automatically combine data obtained during drilling with the post-drilling measurement data, where the integration of the two independently obtained data sets enables the generation of improved geological information and thereby leads to better decision making.

### Borehole Drilling and Depth Logging

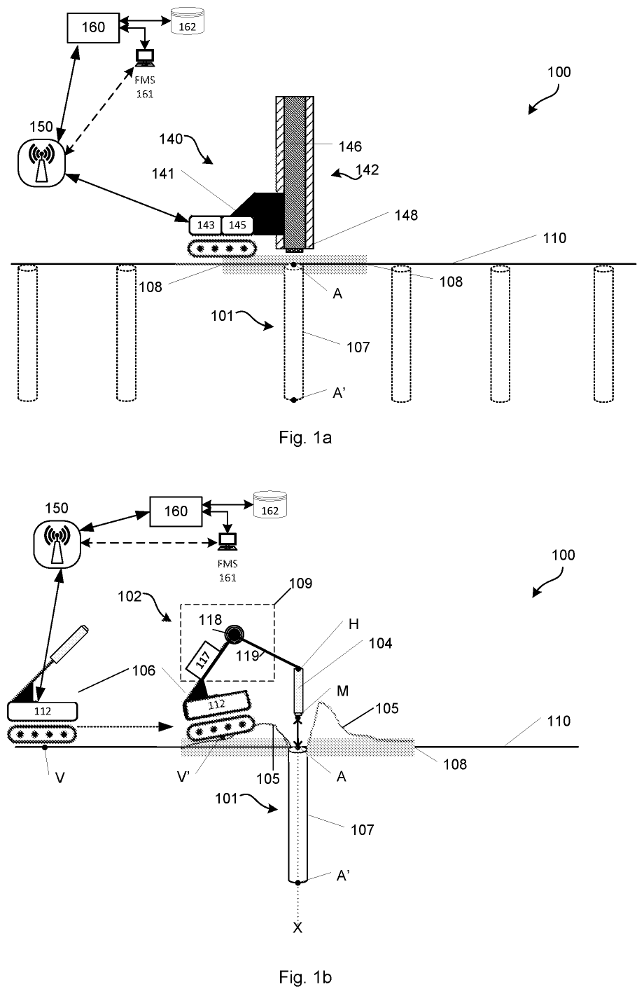

FIGS. 1a and 1b respectively illustrate the drilling of boreholes and subsequently performing logging for boreholes drilled into surface 110 at a site 100, such as a mine site. FIG. 1a shows the desired configuration of a borehole 101 to be drilled in surface 110, as depicted in a pre-drilling state (i.e., prior to creation of the borehole 101). Although FIG. 1a illustrates the application of the proposed techniques to an above ground mining site, this can be extended to other situations where there is a need to log a borehole after it has been drilled. For mining purposes the borehole 101 is part of a surface in which an array of drill holes is created with one or more drill rigs 141 and on which implementations of a measurement apparatus 102 may be employed in an above ground situation. The borehole 101 is created by a drilling apparatus 140 comprising a drill rig 141 configured to position and control the operation of a drilling device 142 including a drill string 146 with a drill bit 148 attached at the end of the drill string 146 that carries out the drilling.

In some embodiments, one or more systems are coupled to the drill rig 141, or device 142, such as a drill guidance system 143 and a drill operation system 145 implemented as one or more computing devices. The drill guidance system 143 includes a navigation component for the drill rig 141, enabling the rig 141 to move to particular positions on the surface 110 to drill the one or more holes (including borehole 101) in accordance with a drilling plan that includes pre-determined locations to drill the boreholes.

In some embodiments, the drill guidance system 143 also includes a location component configured to determine location co-ordinate values of: the drill rig 141 and the drill device 142. For example, the location component is configured to determine the location for the as drilled position (A) of the collar of borehole 101. These location co-ordinate values determined by the drill guidance system 143 may be the same or different to the drilling plan, due to unforeseen differences on the drilling site 100, such as for example wear of the drill bit 148, slight misalignment of the drill rig 141, uneven terrain or other circumstances that arise during drilling vs the optimal circumstances on which the drilling plan was based upon.

The drill operation system 145 controls the operation of the drill rig 141 enabling the drilling of one or more holes on surface 110, including borehole 101. In some embodiments, the drill operation system 145 is configured to process data (i.e., hole pattern data, as described below) to determine particular drilling operations required for hole creation. For example, the drill operation system 145 may dynamically configure the drilling apparatus 140 by selecting a particular drill bit 148, and mode of drilling with the selected bit, based on the desired characteristics of the borehole 101 (e.g., hole length and width).

In some embodiments, the drilling rig 141 is configured to receive hole pattern data representing a desired configuration of the one or more holes, including borehole 101, to be drilled by drill rig 141 on the surface 110. The hole pattern data is provided to the drill rig 141 prior to the commencement of drilling of borehole 101, such as by a data exchange with a computing system included within an operating platform 160. The operating platform 160 may include one or more computing systems configured to perform data storage and/or processing operations on data related to the borehole 101. In some embodiments, the operating platform 160 is configured to exchange data with one or more external systems, such as for example a Fleet Management System (FMS) 161 and/or a data storage system 162.

The hole pattern data may include location data representing desired hole locations for each hole, including borehole 101, and navigation data to navigate the drill rig 141 to the vicinity of the desired hole locations. The drill guidance system 143 is configured to process the location data and the navigation data to navigate the drill rig 141 to the desired location where each particular borehole is to be drilled on surface 110.

The hole pattern data may also include operation data enabling the drilling of borehole 101, in response to the rig 141 arriving at a position on surface 110 enabling the hole to be formed at, or close to, the desired hole location for borehole 101. In some embodiments, the operation data includes drilling information, such as drilling device configuration and operational parameters, to create the holes specified by the hole pattern data.

The drill operation system 145 processes the operation data to control the creation of the borehole 101 by the drill rig 141. This involves positioning the drilling device 142 to commence drilling at, or close to, the desired hole location for borehole 101.

In the described embodiments, the drilling device 142 is a borehole drill including a drill string 146 and a drill bit 148. The drilling of borehole 101 involves positioning the drill string and therefore the drill bit 148 to engage the surface 110 at a first position A. The drill string 146 rotates the drill bit 148 causing the device 142 to excavate material from beneath the ground of the surface 110 to form a hole 107. The hole 107 extends into the ground at the first position A and terminates at a second position A′. In response to the completion of the formation of the hole 101 (i.e., once the end of the hole 107 is formed at the second position A′), the drill string is extracted from the hole 107 and the borehole 101 is formed.

The drilling device 142 is configured to obtain hole drilling data during the drilling of borehole 101. That is, the hole drilling data represents the borehole 101 as drilled by the drilling device 142. In some embodiments, the hole drilling data indicates a configuration of the borehole 101 as a set of as drilled hole parameters including, at least, a collar position indicating a location of the collar of the borehole 101.

In the described embodiments the position of the borehole 101 is represented by the position of the collar of the hole (i.e., the mouth or entrance to the borehole 101 at a level of the surface 110). This is referred to herein as the “collar position” of the borehole. In the example depicted by FIGS. 1a and 1b, the collar position is the first position A, which also corresponds to the desired location of the borehole (as specified in the hole pattern data).

In the described embodiments, the drilling guidance system 143 receives location data including, for example, GPS values indicating a location of the borehole 101. The location data is translated into a representation of the position of the collar in 3D space relative to the surface 110 (i.e., the ground level of the site). The drilling guidance system 143 records the collar position (e.g., A for borehole 101). In some embodiments, the drilling guidance system 143 determines the collar position based on the position of the drill rig 141 and the known position of the drilling device 142, relative to the rig 141, at the commencement of the drilling operation.

In response to the completion of the drilling, the collar position of the borehole 101 is recorded within the hole drilling data. In some embodiments, the drill rig 141 uploads the hole drilling data, including the collar position of the borehole 101, to the operating platform 160 for storage and/or processing. In other embodiments, the drill rig 141 uploads the data to one or more external systems such as fleet management system (FMS) 161 or data storage system 162. The upload may be performed via an intermediate communications network 150, such as the Internet or another wide area network. Alternatively, the hole drilling data may be transmitted from the one or more computer devices of the drill rig 141 to the operating platform 160, and/or to the one or more external systems, via direct connection (e.g., via the connection of a local storage device, or via an Ethernet based local area network transfer).

In some embodiments, the position of the borehole 101 on the surface 110, may differ from the desired hole position represented in the hole pattern data (e.g., due to an obstacle or other barrier preventing placement of the borehole 101 in the desired location). Although the described embodiments depict the borehole 101 as extending vertically into the surface 110, other configurations of the site 100 may include boreholes which are not substantially vertically oriented for all, or part, of the length of the hole.

FIG. 1b depicts the borehole 101 in a post-drilling state (i.e., where the drill rig 141 has been navigated away from the borehole 101 after the drilling operation has been completed for the hole). It is desired to perform logging of the borehole 101 via a measurement apparatus 102, including: a measurement device 104; and an automated, autonomous, or semi-autonomous ground vehicle (AGV) 106, also referred to as a “deployment vehicle”, configured to deploy the measurement device 104 to measure the borehole 101. The measurement device 104 is coupled to the deployment vehicle 106 via a deployment mechanism 109 that is operable to cause the measurement device 104 to move, relative to the vehicle 106, to a position for measurement of the borehole 101. The measurement apparatus 102 further includes a controller 112, which includes a logging component 213 and a deployment vehicle guidance system 214, implemented as one or more computing devices.

The deployment vehicle guidance system 214 includes a GPS receiver component configured to receive location data from one or more GPS transmitter devices (e.g., GPS satellites). The deployment vehicle guidance system 214 operates as a locator device for measuring the location of the vehicle 106. The deployment vehicle guidance system 214 is coupled to the deployment vehicle 106 enabling the guidance system 214 to process the location data in real-time to determine a current position V of the deployment vehicle 106 on the surface 110. That is, the vehicle position V is a Real-Time Kinematic GPS (RTKGPS) location value of the deployment vehicle 106, which is, in the described embodiments, represented as a 3D spatial co-ordinate value.

In the described embodiments, the controller 112 of the deployment vehicle 106 is configured to receive data from the operating platform 160 via the communications network 150. The data received includes hole data of the borehole 101, which may include hole drilling data, and/or hole pattern data. The vehicle guidance system 214 is configured to obtain, from the received hole data of borehole 101, the collar position A. The guidance system 214 processes the collar position A in relation to the current position V of the deployment vehicle 106 to generate movement control operations for directing the deployment vehicle 106 to the vicinity of the borehole 101 (i.e., in a surface region 108 around the collar position A) as required to perform the logging. The position of the deployment vehicle 106 at which the logging is performed is the “deployment vehicle position” denoted V′.

The borehole logging measurements are generated relative to a measurement reference position M indicating a reference location of the measurement device 104. In the described embodiments, the measurement reference position M is a an indication of where the sensors 132 are used to measure the geological parameters of the boreholes prior to or at the commencement of the measurement process (i.e., when the measurement device 104 is deployed to measure the borehole 101). For example, in the described embodiments the measurement position M is located at a base 135 of the measurement device 104, adjacent to a region of the interior of the device 104 that houses the sensors 132 (as described below). In other embodiments, the measurement position M may be located elsewhere on the measurement device 104 (as described below).

The deployment vehicle guidance system 214 is configured to provide the controller 112 with the real-time updated vehicle position V and configuration data of the dimensions and spatial position of the measurement device 104, relative to the deployment vehicle 106, to enable the calculation of the measurement reference position M. For example, in the described embodiments, the measurement device 104 is formed as an elongated cylindrical structure that, in some embodiments, can be up to 4 m in length from top to base.

Drilling of the borehole 101 involves the excavation of ground matter to create the hole 107, and consequently results in the formation of drilling debris 105 (referred to as “tailings”) located in the surface region 108. The measurement position M of the measurement device 104 is impacted by the tailings 105, for example when the measurement device 104 is positioned by the vehicle 106 that is navigated to the collar position A. As depicted in FIG. 1b, the tailings 105 may result in an elevation of a front end of the deployment vehicle 106 and therefore a corresponding elevation of the measurement position M above the ideal position A. In other configurations, tailings 105 cause a depression of the front part of the vehicle 106 and a corresponding depression of the measurement position M below the ideal position A.

Measurement device 104 is configured to generate one or more measurements representing geological parameters of the borehole 101, where the geological parameter measurements have associated depth values. The corrected depth values provide a corresponding correction of the depths against the aforementioned effect of the tailings 105. In one embodiment, the controller 112 performs a correction of depth values representing depths of the measurement device 104, where the controller 112 is implemented as a computing device within or coupled to vehicle 106. In such an embodiment, the deployment vehicle 106 may be a robot, or another type of AGV configured to autonomously log the borehole 101.

In another embodiment, the correction of depth values is performed by one or more computing devices that are external to the measurement apparatus 102 (e.g., a remotely located computing device operating as part of a cloud computing environment). For example, with reference to FIG. 1b the operating platform 160 may include a depth correction computing device (not shown). In some embodiments, the depth correction computing device is a standalone computer (e.g., a server) configured with components that are similar to the components of the 112 described above. The depth correction computing device is configured to receive one or more depth values of the measurement device 104, and determine one or more corrected depth values based on the received depth values, and other data such as the collar position, and the measurement reference position M. In some configurations, the depth correction computing device receives depth values from a data transfer with the controller 112 (e.g., over the communications network 150). In some configurations, the depth correction computing device also receives geological measurement values generated by the measurement device 104, via the controller 112.

The depth correction computing device is configured to receive hole data representing the borehole 101, including the collar position, from a data store 162 or other system of the platform 160. In one configuration, the depth correction computing device determines a measurement reference position M of the measurement device 104. For example, the depth correction computing device may determine a 3D Cartesian position value M based on a corresponding GPS location of the measurement device 104 (e.g., via UTM conversion, as described above). In some embodiments, the measurement reference position M of the measurement device 104 is computed by the controller 112, or the measurement device 104, and provided to the depth correction device in a data exchange between the controller 112 and platform 160.

In some embodiments, the controller 112 is configured to transmit the depth values of the measurement device 104 to the depth correction computing device according to a schedule. The schedule may specify one or more depth data transmission conditions that determine the operation of the controller 112 to provide the external depth correction computing device with the depth values. For example, the schedule may configure the controller 112 to transmit one or more depth values at particular times (e.g., at the end of an operation time period of the apparatus 102), on the occurrence of particular events (e.g., in response to a predetermined number of holes being logged) and/or periodically (e.g., at a minimum of once per day or at the end of a shift) if no other conditions otherwise cause a transmission.

### Depth Measurement and Processing Devices

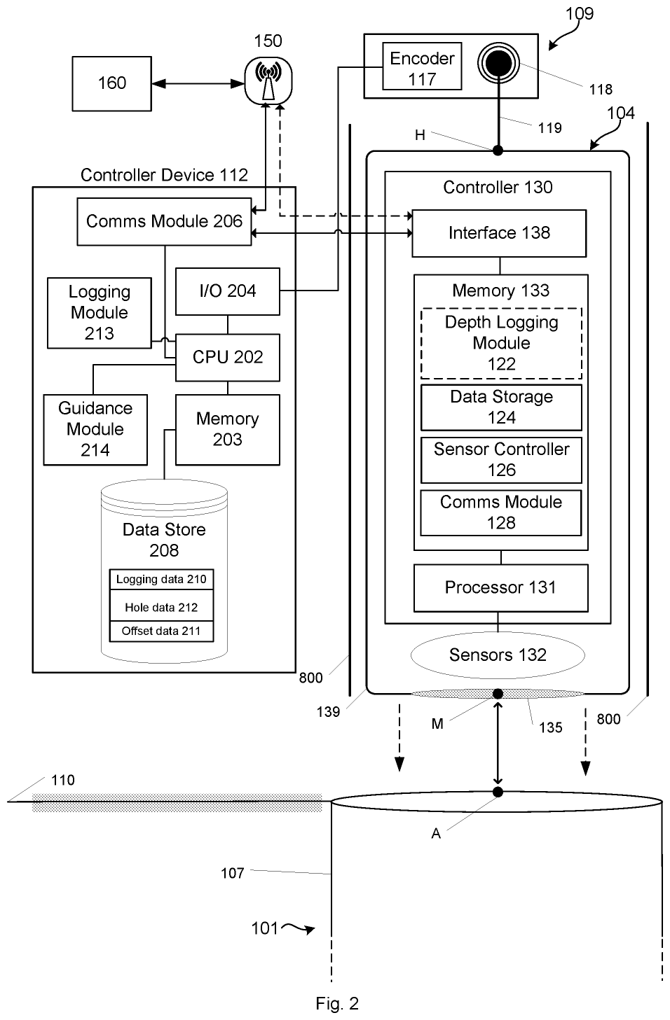

FIG. 2 illustrates the controller 112, measurement device 104 and deployment mechanism 109 of the measurement apparatus 102 of FIG. 1b, according to the described embodiments. In the described embodiments, the controller 112 is coupled to the deployment vehicle 106 and is configured to control operations associated with performing autonomous logging of the borehole 101, and with performing depth correction, including for example: moving/positioning the vehicle 106 in accordance with the hole drilling data, hole pattern data, or other data; positioning the device 104 relative to the vehicle 106; determining the measurement reference position M of measurement device 104; calculating the depth offset between the collar A and the measurement device M positions; initiating the measurement of borehole 101 by device 104 by instructing the deployment mechanism 109 to deploy the device 104; receiving logged data including measurements and depth values, determining the corrected depth values in accordance with the methods described below, and communicating the depth and measurement data elsewhere or storing it within the controller device 112.

Measurement device 104 comprises one or more sensor components 132, and a controller 130, where the sensors 132 and the controller 130 are enclosed in a housing 139. The housing 139 is composed of a resilient material, such as a metal or hard plastic, to provide protection to the controller 130 and sensors 132. The measurement device 104 may then be optionally provided with a protective shroud 800 that is configured to be dimensionally similar to that of the measurement device 104 and having open ends to enable the measurement device to travel 104 therethrough. In the described embodiments, the housing 139 is formed as a cylindrical structure oriented vertically with a base 135 adjacent to the sensors 132. The protective shroud 800 has an open top and bottom through which the measurement device 104 attached to the wireline 119 is deployed. The vehicle 106 is configured to move and support the measurement device 104 together with the protective shroud 800 until deployment, during which the measurement device 104 is moved through the bottom of the shroud 800 (i.e., while the shroud 800 is held fixed). The protective shroud 800 provides additional protection to the measurement device 104 from any flying debris, dust, or other matter that may be present on the mine site.

In the described embodiments, the measurement device 104 is a geological logging tool configured to measure one or more geological parameters of the borehole 101 and/or the formation/strata surrounding the borehole 101. The geological logging tool 104 includes one or more sensors 132 collectively configured to generate data representing one or more geological parameter measurements of the borehole 101 and/or the formation/strata surrounding the borehole 101 in response to the deployment, from the measurement reference position M.

In some embodiments, the measurement device 104 can include local positioning components configured to determine positional and/or orientation information of the measurement device 104 itself and/or the sensors 132. The local positioning components may include, for example, gyroscopes, magnetometers, and/or accelerometers configured to generate data indicating a position, slew, and/or angle of the depth sensors with respect to a local reference point defined at another position on the measurement device 104. In the described embodiments, the local reference point is the point of connection of the deployment mechanism 109 to the measurement device housing 139 or this point could be any other known or identified reference point on the measurement device.

In some embodiments, the local positioning components of the measurement device 104 include a locator device (not shown) such as, for example, a GPS receiver component. The locator device is configured to receive location data and process the location data in real-time to determine at least the measurement reference position M of the measurement device 104 (e.g., by enabling the determination of a GPS co-ordinate value of the measurement device 104 from one or more GPS transmitter devices). The locator device is arranged internally within the housing 139 of the measurement device 104, or is otherwise coupled to the measurement device 104 via a physical attachment to the housing 139.

The deployment of the measurement device 104 to measure the borehole 101 is performed by the deployment mechanism 109. The measurement device 104 is deployed by the lowering the device 104 from the measurement reference position M to the collar position A at the entrance of the borehole 101, and subsequently to end position A′, via a wireline 119 attached to the head of the device 104 at position H.

The wireline 119 is engaged to a winch 118 adapted to deploy an amount of wireline 119 to lower the tool 104 down the borehole 101, the tool 104 being lowered via gravity while in a substantially vertical orientation with base 135 entering the borehole 101 first through the collar position A. The deployment mechanism 109 includes a depth logging device 117 configured to record one or more depth values of the measurement device 104 in response to the deployment. In the described embodiments, the depth logging device 117 is an encoder configured to measure an amount of wireline used to deploy the measurement device 104 downhole during measurement.

In some aspects, the encoder 117 includes digital or analogue circuitry adapted to count successive length values corresponding to indications of the wireline 119 presently deployed. In other aspects, the encoder 117 is a mechanical device configured to read one or more physical properties of the wireline 119 to determine the length. In some aspects, the mechanical device operates by processing one or more measurement units included along the wireline 119 length.

During measurement of the borehole 101 by the measurement device 104, the device 104 is extended from the measurement position M, at which the measurement process commences, to enter the bore 107 at the collar position A. The device 104 traverses the hole 107, in an ideal path along an axis X of the interior of the borehole 101, until the end point A′ is reached (as shown in FIG. 1b). That is, the sensors 132 are configured to generate real-time geological measurement values representing the properties of the borehole 101 along a line passing through the measurement reference position M to the end of the borehole 101 at position A′. The depth values generated by the depth logging device (e.g., encoder 117) provide indications of depth values at one or more internal positions of the bore 107. That is, the one or more geological measurement values generated by the device 104 in response to its deployment to measure the borehole 101 correspond to the one or more depth values generated by the depth logging device (i.e., encoder) 117.

In the described embodiments, the depth values represent the length of the borehole 101 (i.e., the “wireline” or “measured” depth). While in conventional vertical boreholes or wells this coincides with the true vertical depth, in directional or horizontal wells, especially those using extended reach drilling, the two measurement types produce different values.

The controller 130 is configured to control the operation of the sensors 132. The controller 130 includes a non-volatile memory 133 configured to store data and instructions for one or more operational modules of the measurement device 104, including at least a data storage module 124, a sensor controller 126 and a communications protocol 128 coupled to a communications interface 138. The controller 130 further includes a processor 131 configured to transfer data between the sensors 132 and the operational modules 122-128, and to process the data to cause the measurement device 104 to perform the measurement operations described herein.

In some embodiments, the measurement device 104 is configured as an embedded system with the controller 130 and memory 133 implemented as an integrated microcontroller with a RISC architecture, and the sensors 132 configured as peripheral devices providing data to, and receiving control data from, the microcontroller. In other embodiments, the measurement device 104 may be implemented as one or more standard computer systems, such as an Intel Architecture computer system. In other embodiments, the sensors 132 may be integrated with the controller 130, thereby enabling an exchange of data between the operational modules 122-128 and the sensors 132 via an internal controller bus or similar structure.

In the described embodiments, the data storage module 124 is implemented as one or more data structures, such as lists, arrays, and/or tables configured to store data including, at least, the measurement values generated by the sensors 132 and processed by the sensor controller 126. In some embodiments, the data structures are also configured to store additional data including: position data; and depth offset data. The position data includes location values representing the measurement reference position M of the measurement device 104, and the collar position A of the borehole 101. The depth offset data includes the depth offset value determined to correct the depth values recorded during measurement for borehole 101, as described below.

The measurement device 104 is configured to communicate with the controller 112 via the network interface 138. The network interface 138 may include a modem or transceiver configured to access a communications module (e.g., a protocol stack) 128 to perform a data transfer between the devices 106, 112 over a wireless or wired transmission media. In one embodiment a wired connection is established between the controller 130 of the measurement device 104 and the controller device 112, such as via an Ethernet cable. For example, where the controller 112 is located on the measurement vehicle 106, the cable may be housed within a cable enclosure and passed through the deployment mechanism 109 (not shown). In other embodiments, the network interface 138 may implement the IEEE 802.xx family of networking protocols 128 enabling the exchange of information wirelessly with the controller device 112 (e.g., over technologies such as Wi-Fi).

In some embodiments, the measurement apparatus 102 is configured to receive data from one or more computing devices of the operating platform 160. For example, in one embodiment the measurement device 104 receives collar position data from platform 160, where the collar position (A) is the “as drilled” position of the borehole 101 (i.e., as uploaded to the operating platform 160 by the drill rig 141, or some other system that obtained the data from the rig 141). The data exchange between the measurement device 104 and the one or more computing systems of the platform 160 may be performed by a direct connection between the devices (e.g., via Ethernet) or via an intermediate communications network 150 (e.g., where the platform 160 is remotely located from the deployment vehicle 106).

In some embodiments, the relevant data including the collar position A (e.g., hole drilling data, hole pattern data, and/or other data describing borehole 101) is sent to the operating platform 160 by an external device, system or apparatus prior to the measurement activities. For example, the operating platform 160 may be configured to receive hole data from one or more external systems (such as the FMS 161 and/or data store 162), and to subsequently provide the received hole data to the measurement apparatus 102. In other embodiments, the measurement apparatus 102 is configured to receive the hole data from the one or more external systems (e.g., FMS 161), or from the drill rig 141, directly (i.e., without communication with the platform 160).

In the described embodiments, controller device 112 is implemented as a standalone computing device, and comprises a central system bus (not shown), a memory system 203, a central processing unit (CPU) 202, communications component 206, and I/O device interfaces 204. The CPU 202 may be any microprocessor which performs the execution of sequences of machine instructions, and may have architectures consisting of a single or multiple processing cores such as, for example, a system having a 32-or 64-bit Advanced RISC Machine (ARM) architecture (e.g., ARMvx). The CPU 202 issues control signals to other device components via the system bus, and has direct access to at least some form of the memory system 203.

The memory system 203 provides internal media for the electrical storage of the machine instructions required to execute the user application. The memory system 203 may include random access memory (RAM), non-volatile memory (such as ROM or EPROM), cache memory and registers for fast access by the CPU 202, and high volume storage subsystems such as hard disk drives (HDDs), or solid state drives (SSDs).

The processes executed by the controller device 112 are implemented as programming instructions of one or more software modules stored on non-volatile storage of the memory system 203. In some other embodiments, the processes may be executed by one or more dedicated hardware components, such as field programmable gate arrays (FPGAs) and/or application-specific integrated circuits (ASICs). The one or more software modules includes the logging module 213 which is configured to perform the methods of depth logging for the borehole 101, as described herein. Memory 203 may also include one or more general application programs providing methods, data structures or other software services that define data or perform functions as required by the device 112 (e.g., an operating system 216). The data and instructions may reside in multiple parts of the memory system 203, including registers, cache, main memory, and high volume storage.

The I/O device interface 204 provides functionality enabling the user to interact with the device 112 via one or more I/O devices. In some embodiments, the device 112 includes one or more onboard input devices such as a touchpad or touch screen enabling a user to interact with the device 112. The I/O device interface 204 also provides functionality for the device 112 to instruct output peripherals, which may include displays, and audio devices.

In the described embodiments, the encoder 117 is connected to the controller 112 via a specialized I/O connector port of interface 204 enabling the transfer of wireline depth values to the controller 112 in real-time. In some embodiments, the controller 112 is configured to store the depth values as a function of time in order to enable post-processing of the depth values (i.e., using the depth offset, as described below). In other embodiments, the received depth values are automatically pre-processed to account for the depth offset before the values are stored or otherwise associated with the geological measurement data as determined by the measurement device 104.

Communications component 206 is a modem or transceiver device configured to enable the establishment of a logical connection between the controller 112 and other computing devices through a wireless or wired transmission media. For example, in the described embodiments the device 112 is configured to receive hole data representing the borehole 101, including collar position A (or a location corresponding to the same), from the platform 160 via intermediate WAN 150. The communications component 206 is configured to enable device 112 to receive one or more depth measurement values generated by the measurement device 104, via a data transfer with the network interface 138 of the measurement device 104.

The controller 112 implements one or more service modules including a structured query language (SQL) support module (e.g., MySQL) enabling data to be stored in, and retrieved from, a data store 208 (such as an SQL database). In the described embodiments, the data store 208 is formed within the memory system 203 and includes data tables, or other structures, configured to store, for the borehole 101: hole data 212; offset data 211; and borehole logging data 210. Offset data 211 indicates a determined error component of the depth values expressed as at least one offset value, as described herein below. In some embodiments, the data store 208 is configured to store other data associated with borehole 101, such as hole pattern data. The borehole logging data 210 includes one or more corrected depth values that account for the determined error, as generated by the controller 112. In some embodiments, the data store 208 is also configured to store the depth values received from the deployment mechanism 109 whether corrected or not.

The skilled person in the art will appreciate that many other embodiments may exist including variations in the hardware configuration of device 112, and the distribution of program data and instructions to execute the depth logging methods described herein.

### Depth Logging Process with Error Correction

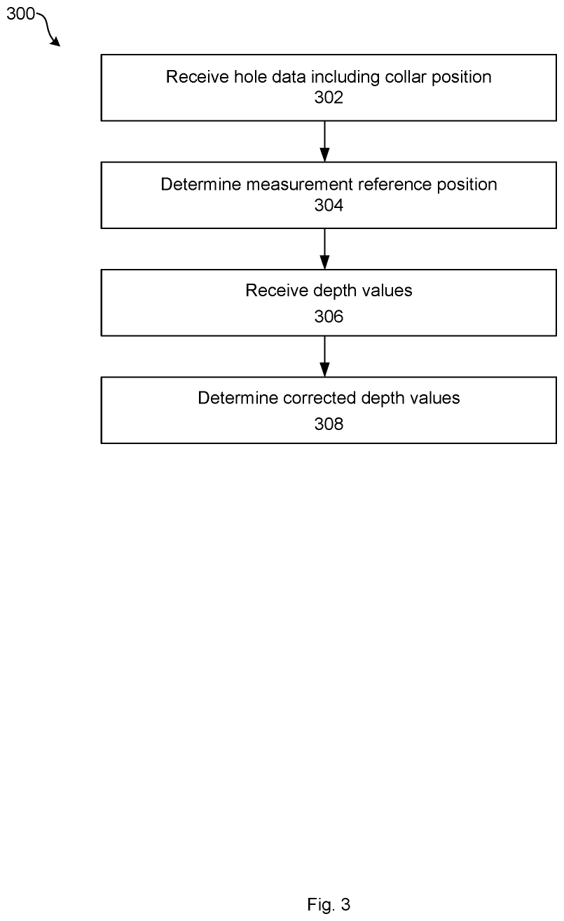

FIG. 3 illustrates a flow diagram of a method 300 for an embodiment in which the depth of borehole 101 is logged by the controller device (CD) 112 of a measurement apparatus 102. At step 302, the CD 112 receives hole data representing the borehole 101. The hole data may include hole drilling data, hole pattern data, and/or any other data associated with borehole 101 that includes a location of the collar of the borehole 101. In some embodiments, the hole data is received from platform 160, for example in the form of hole drilling data uploaded to the system 160 by the drill rig 141. In other embodiments, the hole data may be received directly from the drill rig 141, or from another external system e.g., repository 162 or FMS 161. In some embodiments, the hole data may not include any “as drilled” data of the borehole 101. For example, the hole data may be obtained as a result of surveying of the site 100 in the form of “planned” or “anticipated” hole pattern data.

In some embodiments, the CD 112 is configured to request the hole data from the platform 160 via the transmission of a hole data request message of a predetermined form. In some embodiments, the CD 112 is configured to receive the hole data as part of a data update provided to the measurement apparatus 102 by the platform 160. The data updates may be provided periodically, semi-periodically, or as ad-hoc update events (e.g., in response to a dynamic change in the conditions of the site 100, such as the drilling of one or more new boreholes).

The hole data includes at least: an indication of the borehole 101, such as a hole index or ID value identifying the borehole 101; and the collar position A indicating the location of the collar of the borehole 101. CD 112 stores the hole data in the data store 208 within the appropriate data structure 212. Logging of borehole 101 is performed by the measurement apparatus 102. The CD 112 is configured to transmit the hole data to the deployment vehicle guidance system 214 enabling the system 214 to guide the deployment vehicle 106 to the surface region 108 to perform logging.

In some embodiments, the deployment vehicle 106 is an autonomous guided vehicle (AGV) configured to guide itself to the vehicle location V′ on the surface region 108. Guidance system 214 generates control instructions to control the operation of one or more motors of the vehicle 106 to drive the vehicle towards the collar position A of the hole data. Guidance system 214 implements an object detection and pathing system (e.g., using one or more of laser targeting, inertial sensing, and natural feature detection) to enable the vehicle 106 to arrive at a vehicle measurement location V′, being the location for the measurement of the borehole 101, in the presence of obstacles on the site 100.

Location V′ is determined by the guidance system 214 based on a set of known vehicle positioning parameters, the parameters enabling the measurement apparatus to determine a suitable location (the “vehicle measurement location”) V′ for the deployment vehicle 106 to log the borehole 101. For example, the vehicle positioning parameters may include the size and/or dimensions of the deployment mechanism 109, the housing 139, or protective shroud 800 and parameters describing the spatial range of which the measurement device 104 can be extended by the deployment mechanism 109. The guidance system 214 processes the vehicle positioning parameters in conjunction with the collar position A, and the real-time determined vehicle position V, to calculate the measurement position V′. In response to the vehicle arriving at the measurement position V′ the guidance system 214 is configured to maintain the vehicle at the position V′ to perform the logging.

In response to the deployment vehicle 106 arriving at vehicle measurement location V′ at the surface region 108, the deployment vehicle 106 performs a positioning operation to position the measurement device 104 at the measurement reference position M. The positioning operation is conducted prior to the measurement device 104 generating measurements on the borehole 101. In some embodiments, the positioning of the measurement device 104 is controlled by a device positioning system (not shown) of the measurement apparatus 102. The device positioning system performs the measurement device positioning operation based on the collar position A and the current position of the vehicle at the vehicle measurement location V′. The measurement device positioning operation causes the deployment mechanism 109 and/or other mechanical components of the apparatus 102 to move, resulting in the positioning of the base 135 as close as possible to the collar position A.

After the completion of the measurement device positioning operation, the measurement device 104 resides at the measurement reference position M. In the described embodiments, this involves the placement of the base 135 at position M. In other embodiments, the measurement position M may correspond to a region of the measurement device 104 other than the base 135. For example, the measurement reference position M may correspond to a centre point of the housing 139 along its length, or with the head of the device 104 at position H.

At step 304, the CD 112 determines the measurement reference position M of the measurement device 104 for the generation of depth measurements, by the measurement device 104, for the borehole 101. In the described embodiments, the measurement reference position M is recorded as a 3D relative position value. The CD 112 determines the measurement reference position M by processing location data provided by a locator device of the deployment vehicle 106 and/or the measurement device 104. For example, the CD 112 receives location data from vehicle 106 including: the vehicle measurement location V′ provided by the guidance system 214; and the vehicle positioning parameters, provided by the device positioning system. The logging module (LM) 213 of the CD 112 processes the vehicle measurement location V′ and vehicle positioning parameters to calculate the measurement reference position M. Alternatively, or in addition, the CD 112 is configured to receive location data from the GPS receiver of the measurement device 104 and to process the location data to determine position M.

The CD 112 may be configured to utilize location data from both the deployment vehicle 106 and the measurement device 104, as provided by the respective local locator devices. For example, the location data obtained from the deployment vehicle 106 may be processed to verify a corresponding location co-ordinate value received from the measurement device 104, and/or to perform a correction of the co-ordinate value received from the measurement device 104 if necessary.

For example, the LM 213 may be configured to process the vehicle measurement position V′ based on slew and angle data determined from the positioning of the measurement device 104 relative to the vehicle 106 and/or in some other embodiments position detection components of the sensors 132. That is, the LM 213 is able to account for any non-vertical orientation of the measurement device 104 in its position at reference point M. The LM 213 stores the determined measurement reference value M as a data structure within memory 203. For example, the 3D Cartesian form of a measurement position M=(xₘ, yₘ, zₘ) may be stored as a floating point array m of length 3, where each component is given by m[0]=xₘ, m[1]=yₘ, and m[2]=zₘ.

In other embodiments, the measurement reference position M is represented using an alternative coordinate system, such as for example by survey bearing values. The LM 213 is configured to convert relative coordinate value data for each position (e.g., the measurement reference position M, the collar position A, head position H, etc.) to a common coordinate format, such as to 3D Cartesian coordinate values in the described embodiments, for processing by the controller 112. In other embodiments, controller 112 may be configured to use a different coordinate format to process the location and/or position values and determine the depth offset.

The controller 112 is configured to instruct the measurement apparatus 102 to commence a measurement of the borehole 101. In the described embodiments, the commencement of the measurement involves the operation of the deployment mechanism 109 to deploy the measurement device 104 into the borehole 101 (e.g., after the CD 112 detects that the device 104 is properly positioned at M). Depth value data is generated by the depth logging device 117 of the deployment mechanism 109 to indicate one or more depths of the device 104, as the device 104 is moved from position M to the collar position A, and subsequently to the end position A′.

In the described embodiments, the sensors 132 are configured to relay the generated geological parameter data to the sensor controller 126 within the device 104 in real-time. The sensor controller 126 stores the received geological parameter data in the data storage module 124. In some embodiments, the measurements are recorded “in-the-hole” on a portion of memory of the sensors 132. At termination of the measurement operation, the parameter values are extracted from the sensor memory by the sensor controller 126, and stored as data in the data storage module 124. Depth values are simultaneously measured against time by the encoder 117, such that in-the-hole depths of the recorded measurements can be corrected in the same way as real-time measurements.

At step 306, the CD 112 receives, from the encoder 117, the one or more depth values of the measurement device 104 in response to the deployment, from the measurement reference position M, of the measurement device 104 to measure the borehole 101. The encoder 117 transmits the generated depth data to the CD 112, via a wired connection to an I/O port of the CD 112, either: i) during the measurement process, and optionally in real-time as the depth values are generated; or ii) after the measurement process has ceased. In other embodiments, the depth data may be transferred via a wireless communication channel, such as via network 150.

The received depth data is passed to the LM 213 by the processing unit (CPU) 202. In some embodiments, the LM 213 is configured to store the received depth values in the data store 208. In other embodiments, the LM 213 maintains the received depth values in a buffer, or a similar fast-access portion of memory 203, to facilitate the depth correction operations described below.

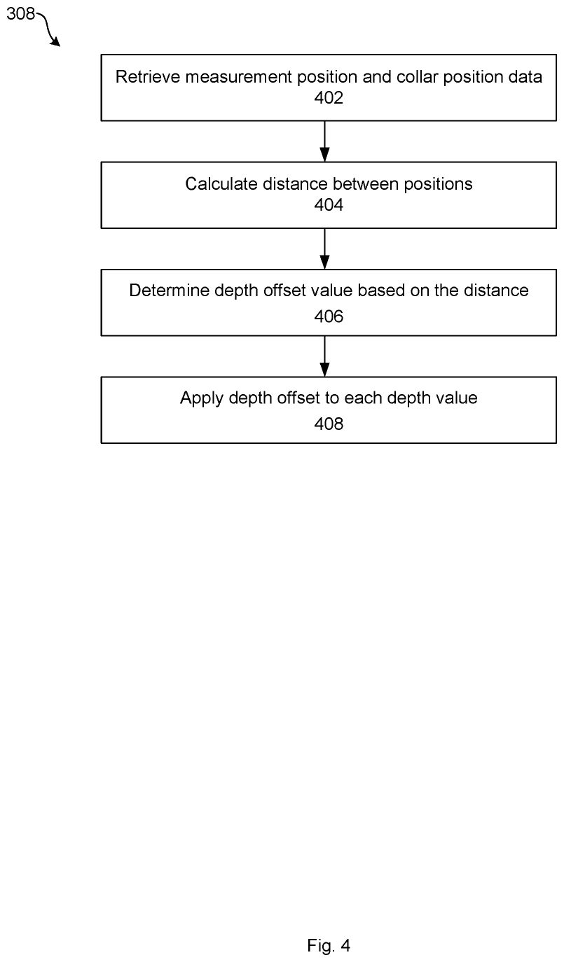

At step 308, the CD 112 determines one or more corrected depth values of the borehole 101 based on the one or more depth values, the collar position A, and the measurement reference position M. FIG. 4 illustrates a sub-process for determining the corrected depth values in accordance with the described embodiments. At step 402, the CD 112 retrieves the measurement reference position and collar position value(s). The LM 213 retrieves data representing the collar position A from the hole data 212 for the borehole 101. The LM 213 converts the 3D Cartesian representation of collar position A=(xₐ, yₐ, zₐ) into a floating point array variable c, with c[0]=xₐ, c[1]=yₐ, and c[2]=zₐ for processing by the LM 213. The LM 213 retrieves the measurement reference position value M from memory 203 and loads the corresponding component values into floating point array variable m.

The depth values generated by the encoder 117 are corrected against a depth offset of the measurement reference position M relative to the collar position A. The CD 112 determines the depth offset based on the relative difference between the collar position A, and the measurement reference position M. That is, the offset represents an error component that exists in the depth measurements produced by the measurement device 104 without the depth logging methods described herein. This may result, for example, from an inability to position the measurement device 104 accurately at the borehole collar position A before commencing the depth measurement (i.e., the depth offset is non-zero in cases where M=/=A).

In the described embodiments, the CD 112 calculates the depth offset value by, at steps 404 and 406, determining a distance between the measurement reference position and the collar position. The distance value represents the scalar component of an “error value” associated with the depth measurements generated by the measurement device 104. Then, at step 408, one or more corrected depth values are determined by applying the depth offset to each of the one or more depth values generated by the measurement device 104. In some implementations, the application of the depth offset (e.g., via an addition operation or a subtraction operation) is based on whether the measurement reference position is above the collar position or otherwise. In other implementations, application of the depth offset involves a fixed operation (e.g., subtraction) and the sign of the depth offset is selectively set based on the relative relationship between the measurement reference and collar positions. Irrespective of the implementation, the determination and application of the depth offset produces an adjustment of the one of more measured depth values that accounts for whether the measurement reference position is above the collar position or otherwise.

For example, in the described embodiments the application of the depth offset to each of the one or more depth values involves determining a distance value between the measurement reference position and the collar position (i.e., the error value). Then, a sign of the error value is set based on whether the measurement reference position is above the collar position or otherwise (i.e., to form the depth offset). According to one implementation, the depth offset value is positive in response to a vertical elevation of the measurement device 104 from the entrance to the borehole 101, and negative in response to a depression of the measurement device 104 from the entrance to the borehole 101. In this implementation, the application of the depth offset to each of the one or more depth values further involves a subtraction operation of the depth offset value from the corresponding measured depth value. In other embodiments, an alternative approach may be implemented to selectively set the sign of the error value and to apply the resulting depth offset to each of the measured depth values (e.g., positive for relative depression of the measurement device 104, and negative for relative elevation of the measurement device 104, and the addition of the depth offset value to each measured depth value). In other embodiments, the error value may not be subjected to a selective sign change to determine the depth offset value, such that the error value is used directly as the depth offset value. The application of the depth offset to each of the one or more depth values then involves dynamically performing an addition or subtraction operation based on whether the measurement reference position is above the collar position or otherwise.

In the described embodiments, step 408 generates each corrected depth value by applying a single depth offset value to the uncorrected measured depth value. In some other embodiments, the depth offset value may be effectively and equivalently applied, to a given uncorrected measured depth value, by iteratively or repeatedly applying fractional or partial values of the whole depth offset. For example, the corrected depth value d_{correct} may be generated by applying a depth offset value d_{offset} to an uncorrected measured depth d as d_{correct}=d−d_{offset}.Alternatively, corrected depth value d_{correct} may be generated by twice subtracting d_{offset}/2 from d and then setting d_{correct} as the result.

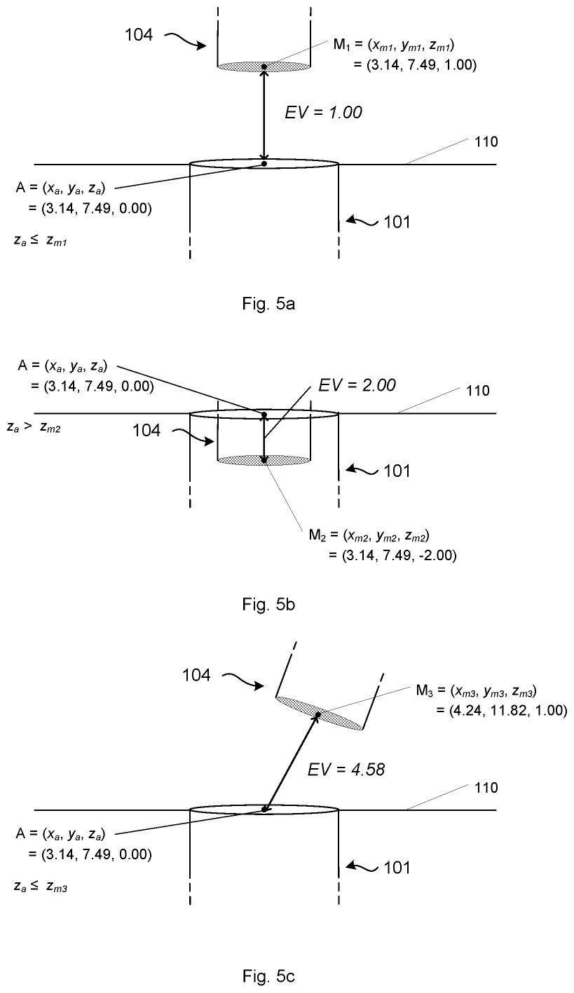

FIGS. 5a, 5b, and 5c illustrate, examples of the methods used for the determination of the distance and the depth offset values by the CD 112 for different measurement reference positions M₁ and M₂, relative to a common borehole collar position A. In the illustrated examples the measurement reference position M is determined to correspond to the base 135 of the measurement device 104. The skilled addressee will appreciate that in other embodiments, the measurement reference position M may correspond to a different part of the measurement device 104 (e.g., a centre point of the housing 139 along its length, or head position H).

In the described embodiments, the distance between the measurement reference and the collar locations is calculated as the Euclidean distance between the positions of M and A. In other embodiments, alternative distance metrics may be used to represent the error value (e.g., depending on the coordinate format of the positions M and A). With reference to FIG. 5a, the measurement reference position and collar position are 3D Cartesian points M₁=(xₘ_{₁}, yₘ_{₁}, zₘ_{₁}) and A=(xₐ, yₐ, zₐ) respectively. The error value EV is calculated as the distance between the reference and collar positions. For M₁ the EV value is given by:

$$EV = + √ ( {( {x}_{a} - {x}_{{m}_{1}} )}^{2} + {( {y}_{a} - {y}_{{m}_{1}} )}^{2} + {( {z}_{a} - {z}_{{m}_{1}} )}^{2} )$$

The LM 213 calculates the distance value by performing corresponding floating point arithmetic operations with array variables c and m, and stores the resulting distance a separate variable e. In the example of FIG. 5a the EV value given by:

$$EV = √ ( {( 3.14 - 3.14 )}^{2} + {( 7.49 - 7.49 )}^{2} + {( 0 - 1. )}^{2} ) = 1.$$

The error values of the depth measurements are positive scalar quantities. The LM 213 calculates the depth offset value by selectively setting the sign of the EV value based on whether the measurement reference position is above the collar position or otherwise. The elevation or depression of the measurement reference position relative to the collar position is determined by comparing the z components zₐ and zₘ_{₁}. In FIG. 5a, measurement reference position M₁ is located vertically above the collar position A, such that the zₐ<zₘ_{₁}, and depth offset is therefore given by: offset=EV=1.00.

FIG. 5b illustrates an alternative case in which the measurement reference position, as represented by Cartesian position M₂=(xₘ_{₂}, yₘ_{₂}, zₘ_{₂}), is below the collar position represented by position A=(xₐ, yₐ, zₐ) such that zₐ>zₘ_{₂}. This may occur, for example, in response to the measurement vehicle 106 experiencing a depression relative to a reference plane of the collar of the borehole 101 (thereby resulting in the base 135 of the measurement device 104 passing into the entrance of the borehole 101 when at the measurement position M). With reference to FIG. 5b, the error distance value between the collar and measurement reference positions is:

$$EV = √ ( {( 3.14 - 3.14 )}^{2} + {( 7.49 - 7.49 )}^{2} + {( 0 - ( - 2. ) )}^{2} ) = 2.$$

In this case, and according to the described embodiments, the depth offset is determined by setting the sign of the EV value as negative, such that offset=(−1)×EV=−2.00. In some embodiments, such as those where the CD 112 is configured to receive raw (i.e., uncorrected) depth values, the corrected depth values are generated by a depth post-processing process involving the application of the offset to each depth value. A subtraction operation is applied in the described embodiments, according to: corrected depth=raw depth−offset.

For example, with reference to FIG. 5a, the offset value of 1.00 is subtracted from the (raw wireline) depth value produced by the encoder 117 as the device 104 is moved from position M to end position A′. The resulting corrected depth is less than the initially determined depth thereby accounting for the elevated position of the measurement device base 135 relative to the entrance of the borehole 101. For the configuration of FIG. 5b, the offset value of 2.00 is effectively added (i.e., by subtracting −2.00) to the depth value produced by the encoder 117, resulting in a corrected depth that accounts for the depressed position of the measurement device base 135 relative to the entrance of the borehole 101.

In the examples of FIGS. 5a and 5b, the x and y component values are common for the collar position A and the measurement references M₁ and M₂. As a result, the EV value is equal to the difference in the z components |zₐ−zₘ|. FIG. 5c illustrates an alternative configuration in which the measurement reference position M₃=(xₘ_{₃}, yₘ_{₃}, zₘ_{₃}) is not vertically aligned with the collar position A. As a result, the error value EV is not equal to the difference in the z components of the collar and measurement reference positions:

$$EV = √ ( {( 3.14 - 4.24 )}^{2} + {( 7.49 - 11.82 )}^{2} + {( 0 - 1. )}^{2} ) = 4.58$$

In some embodiments, the LM 213 is configured to implement the depth correction operations as one or more programmed functions or routines that are translated into corresponding logical operations executed by the CPU 202. For example, the LM 213 may be configured to execute a function to determine the depth offset value based on the data in array variables di/and m[i], i=0 . . . 2 with c and m as arguments, according to the following code:

```
double offset = 0;
int dim = 3;
for(int i=0; i<dim; ++i){
  offset += (c[i]−m[i])*(c[i]−m[i]);
  offset = sqrt(offset);
}
if(c[dim−1]>m[dim−1]) offset = −offset;
```

In some embodiments, the LM 213 is configured to determine the depth offset value based on a subset of the component data for positions M=(xₘ, yₘ, zₘ) and A=(xₐ, yₐ, zₐ) For example, in the illustrated configurations of FIGS. 5a and 5b the measurement reference positions M₁ and M₂ are offset from the collar position A only in the vertical dimension. The LM 213 may be configured to detect instances where the measurement reference M is substantially vertically oriented with the collar position A, such as by checking whether the difference in the non-vertical components of the measurement and collar positions are each less than a pre-specified threshold value, and, if so, to determine the depth offset directly as the difference in the vertical component values.

The LM 213 is configured to generate logging data 210 representing the corrected depth values against the logged geological data of the borehole 101. In some embodiments, the logging data 210 includes the hole data, a portion of hole data, or a reference to a storage location of the data. The LM 213 transmits the logging data 210 to one or more external systems, such as operating platform 160, via the communications device 206. In some embodiments, the LM 213 stores a copy of the logging data 210 in the data store 208.

In some embodiments, the corrected depth values are generated by the measurement device 104 and are recorded in local memory 133 of the controller 130 for uploading to the operating platform 160. With reference to FIG. 2, in such embodiments the controller 130 of the measurement device 104 includes a depth logging module 122 configured to perform depth analysis operations analogous to the operations of the LM 213 of the CD 112.

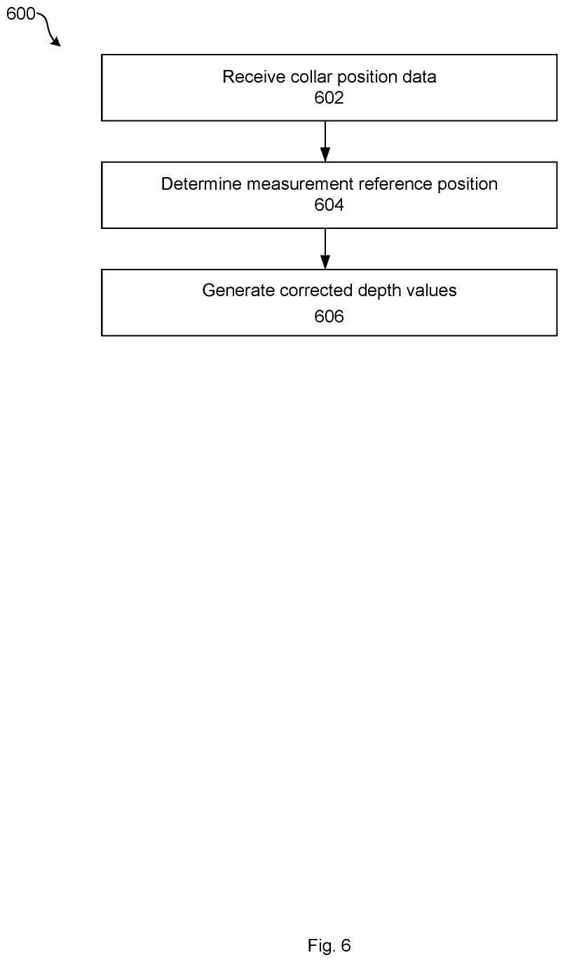

FIG. 6 illustrates a flow diagram of a method 600 for logging of borehole 101 by the measurement device 104 according to one embodiment. At step 602, the measurement device 104 receives an indication of the collar position A of the borehole 101. In some embodiments, the measurement device 104 is configured to receive the collar position A as part of hole data provided to the device 104 by the platform 160. For example, the hole drilling data, containing at least the indication of the collar position A, may be initially uploaded to a FMS 161 and then sent to the platform 160 for subsequent transmission to the device 104 via network 150. In other embodiments, the measurement device 104 is configured to retrieve the collar position data from a pre-specified data storage location, such as an area of local storage (e.g., data storage module 124), a data storage device of the platform 160 (not shown), or another storage device external to the operating platform 160, such as data store 162.

At step 606, the measurement device 104 determines the measurement reference position M indicating the relative location of the measurement device 104 to measure depths of the borehole 101. In some embodiments, the measurement device 104 receives the vehicle measurement location V′ from the guidance module 214 and the vehicle positioning parameters from the device positioning system, enabling a calculation of the position M as described above.

In other embodiments, the measurement device 104 includes a GPS receiver configured to independently generate location values used to determine the measurement reference position M (i.e., without requiring knowledge of the vehicle location V′ and/or the positioning parameters). The processor 131 generates position M=(xₘ, yₘ, zₘ) based on location data provided by the GPS receiver and the output of one or more skew or angle detection components of sensors 132. In some embodiments, the processor 131 stores the determined measurement reference position M in the data storage module 124.

At step 606, the measurement device 104 generates one or more corrected depth values of the borehole 101 using the collar position A and the determined measurement position M. Depth logging module 122 retrieves data indicating the collar position A and the measurement reference position M from data storage 124. The depth logging module 122 of the device 104 is configured to calculate the depth offset based on the relative difference in the collar position A and the measurement reference position M (as in steps 404 and 406 of process 308 performed by the CD 112).

In some embodiments, the measurement device 104 is configured to generate the corrected depth values by firstly obtaining uncorrected or “raw” depth values, as in step 306. In such embodiments, encoder 117 is configured to transmit the depth value data to the controller 130 of the device 104 via the interface 138. The depth logging module 122 generates corrected depth values from the raw depth values received from the encoder 117 by subtracting the offset, according to corrected depth=raw depth−offset. In such embodiments, the depth logging module 122 of the device 104 operates analogously to the CD 112 in performing a post-processing operation to uncorrected depth values initially obtained from the deployment mechanism 109.

In other embodiments, the controller 130 generates the corrected depth values by incorporating the depth offset into each measurement obtained for the borehole 101. The processor 131 provides the depth offset value to the sensor controller 126. This enables the measurement device 104 to produce measurements with accurate depths that inherently compensate for the difference in measurement reference and collar positions in real-time, and without any on-board or external depth post-processing operation.

In some embodiments, the controller 130 is configured to determine the measurement position relative to the collar position of the borehole. The depth logging module 122 is configured to detect the measurement reference position M being above the collar position A (i.e., based on the difference in the z-component values, as described above). In such cases, the controller 130 may be configured to delay the generation of the one or more geological measurement values of the borehole, and the one or more corrected depth values, until the measurement device 104 reaches the collar position A of the borehole 101 after the measurement device is deployed from the measurement position M.

For example, the controller 130 pre-calculates the depth offset between positions M and A (as described above), and compares the depth offset value to depth values received from the encoder 117. In the above configuration, while the received depth values are less than the offset, the device 104 has not yet reached the collar position A (i.e., it is between M and A). Accordingly, the controller 130 delays the generation of geological parameter measurements until the received depth values reach the offset value, and subsequently records the measured geological parameter values in association with the corrected depth (i.e., as given by the encoder received depth−offset) as the device 104 is lowered from position A to A′.

The depth logging module 122 is configured to generate logging data representing the one or more geological measurement values and corresponding corrected depth values, and transmits the logging data to one or more external systems for an end user to interpret further or to input into a geological block modelling software, via the communications interface 138. In some embodiments, the depth logging module 122 stores a copy of the logging data in the data storage 124.

### Example Logs with Raw and Corrected Depth Measurements

With reference to FIGS. 1a and 1b, the measurement reference position M may be influenced by the measurement vehicle position V′, where the presence of the tailings 105 on the surface 108 causes the vehicle 106 to be raised or lowered relative to a reference plane containing the collar position A of the borehole 101. This results in a difference between the spatial locations of the measurement position (M) and the collar (A), where the difference may change unpredictably over successive attempts at depth measurement.

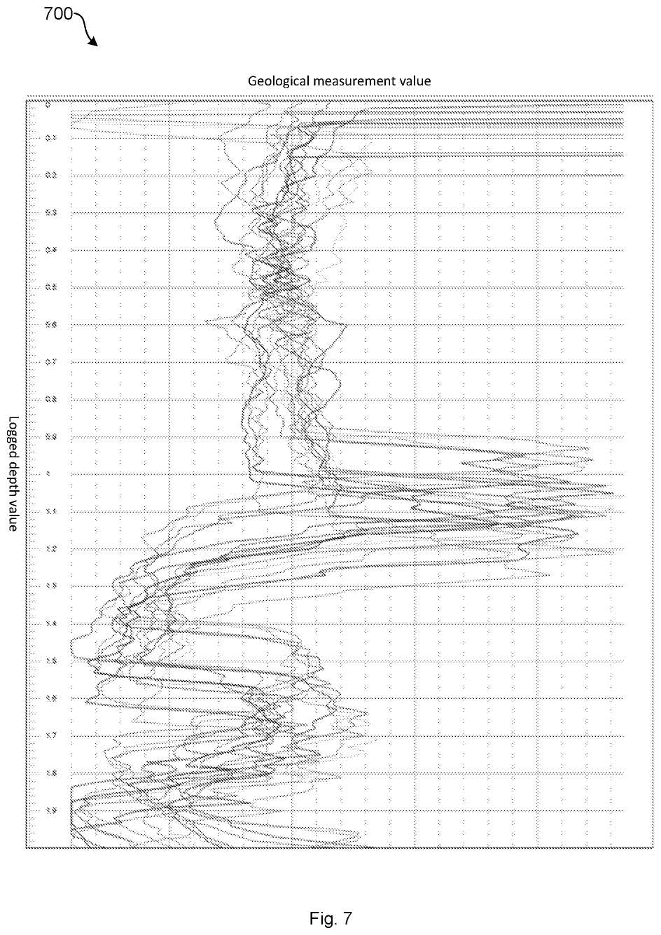

FIG. 7 illustrates an example set 700 of post-drilling measurements logged for a borehole without any depth correction. Over each of multiple logging runs, there is variation in the measurement device position to collar position offset. This may occur, for example, due to differing amounts of elevation or depression of the measurement vehicle 106 from dynamic variation in the physical profile of the surface region 108 around the collar position A between runs. The variable offset in the position of the measurement device 104 in each logging run results in the observed misalignment of the individual line data plots of geological measurements against recorded depths of the measurement device 104.

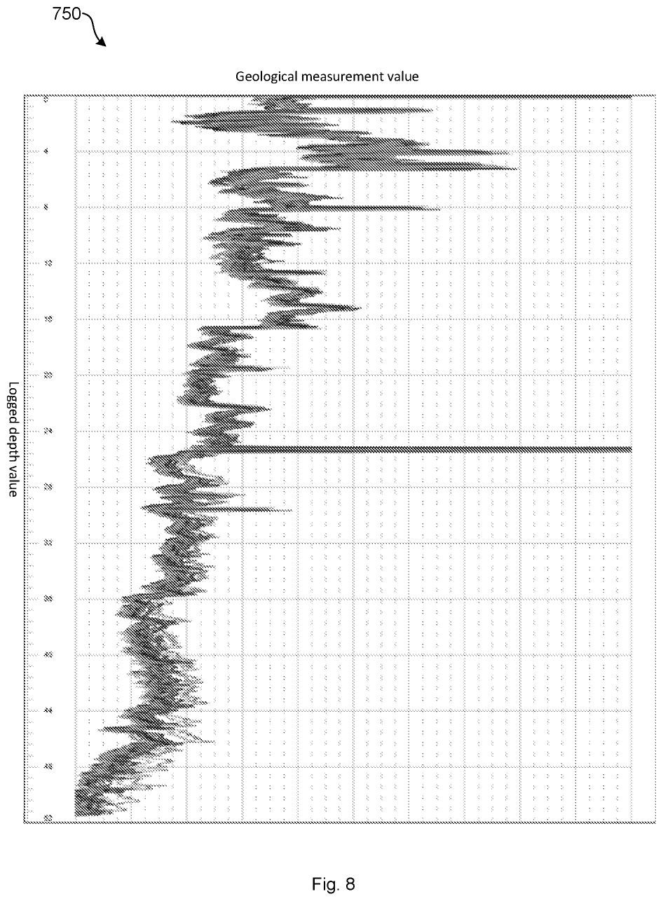

FIG. 8 illustrates an example set 750 of post-drilling measurements logged for a borehole according to the logging processes described herein (i.e., with depth correction applied). As illustrated by FIG. 8, the techniques described herein are advantageous in that the CD 112 is configured to automatically generate corrected depth values that account for different offsets between the measurement and collar positions during each logging run. That is, the proposed techniques are able to provide automated depth correction for the measurement device without knowledge of the surface region profile or how it has changed since measurements were previously obtained. The result is improved consistency in sets of post-drilling logs 750, where the alignment of the line data plots (i.e., of geological measurements against corrected recorded depths) is significantly improved compared to the set of logs 700 that are produced using raw (uncorrected) recorded depths.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method for correcting depth values of a measurement device used to log a borehole relative to the borehole collar, comprising:
receiving hole data representing the borehole, wherein the hole data includes at least a collar position indicating a location of the collar of the borehole;
determining a measurement reference position indicating a reference location of a measurement device configured to be deployed into the borehole;
receiving, from a depth logging device, one or more depth values of the measurement device in response to the deployment, from the reference location, of the measurement device to measure the borehole; and
determining, based on the one or more depth values, one or more corrected depth values to correct for a difference between the collar position and the measurement reference position.

2. The method of claim 1, wherein the one or more corrected depth values are corrected against a depth offset of the measurement reference position relative to the collar position.

3. The method of claim 2, wherein the depth offset is determined by determining a distance between the measurement reference position and the collar position, and the one or more corrected depth values are determined by applying the depth offset to each of the one or more depth values generated by the measurement device.

4. The method of claim 3, wherein the application of the depth offset is based on whether the measurement reference position is above the collar position or otherwise.

5. The method of claim 1, to wherein the measurement device is positioned at the reference location by a deployment vehicle, the deployment vehicle being positioned at a corresponding vehicle location at a surface region around the collar position.

6. The method of claim 5, wherein the deployment vehicle is an autonomous vehicle configured to guide itself to the vehicle location based on the hole data.

7. The method of claim 5, wherein the reference location of the measurement device is determined by the deployment vehicle based on the vehicle location.

8. The method of claim 1, wherein the reference location of the measurement device is determined by processing location data provided by a locator device within, or coupled to, at least one of: the deployment vehicle; and the measurement device.

9. The method of claim 1, wherein the measurement device is a geological logging tool configured to generate one or more geological measurement values of the borehole in response to the deployment of the measurement device to measure the borehole, the one or more geological measurement values corresponding to the one or more corrected depth values.

10. A method for correcting depth values of a measurement device used to log a borehole relative to the borehole collar by a measurement apparatus, including:
receiving a collar position of a borehole, wherein the collar position indicates a location of the collar of the borehole;
determining a measurement reference position indicating a reference location from which a measurement device is to be deployed to measure the borehole; and
generating, based on the collar position and the measurement position, one or more corrected depth values to correct for a difference between the collar position and the measurement reference position of the measurement device in response to the deployment, from the reference location, of the measurement device to measure the borehole.

11. The method of claim 10, wherein the one or more corrected depth values are corrected against a depth offset of the measurement reference position relative to the collar position.

12. (canceled).

13. The method of claim 12, wherein the application of the depth offset is based on whether the measurement reference position is above the collar position or otherwise.

14. The method of claim 12, wherein the one or more corrected depth values are generated by incorporating the depth offset into the determination of one or more depths of the borehole.

15. The method of claim 10, wherein the measurement device is positioned at the reference location by a deployment vehicle, the deployment vehicle being positioned at a corresponding vehicle location at a surface region around the collar position.

16. The method of claim 15, wherein the deployment vehicle is an autonomous vehicle configured to guide itself to the vehicle location based on the hole data.

17. The method of claim 15, wherein the reference location of the measurement device is determined by the deployment vehicle based on the vehicle location.

18. The method of claim 15, wherein the reference location of the measurement device is determined by processing location data provided by a locator device within, or coupled to, at least one of: the deployment vehicle; and the measurement device.

19. The method of claim 10, wherein the measurement device is a geological logging tool configured to generate one or more geological measurement values of the borehole in response to the deployment of the measurement device to measure the borehole, the one or more geological measurement values corresponding to the one or more corrected depth values.

20. (canceled).

21. (canceled).

22. A borehole measurement apparatus for correcting depth values used to log a borehole relative to the borehole collar comprising:
a controller device configured to control operations of the borehole measurement apparatus associated with performing a logging of the borehole;
a measurement device configured to generate one or more geological measurement values of the borehole in response to the deployment of the measurement device into the borehole from a reference location; and transmit the one or more geological measurement values to the controller device; and
a depth logging device configured to: generate one or more depth values of the measurement device in response to the deployment, from the reference location, of the measurement device to measure the borehole; and transmit the one or more depth values to the controller device,
wherein the borehole measurement apparatus is configured to communicate with a depth correction computing device external to the borehole measurement apparatus, the depth correction computing device having:
a communications interface to receive data from at least the controller device;
at least one computer processor to execute program instructions; and
a memory, coupled to the at least one computer processor, to store program instructions for execution by the at least one computer processor, wherein the depth correction computing device is configured to:
receive hole data representing the borehole, wherein the hole data includes at least a collar position indicating a position of the collar of the borehole;
receive, via the communications interface, at least the one or more depth values generated by the depth logging device; and
determine, based on the one or more depth values, one or more corrected depth values to correct for a difference between the collar position and a measurement reference position indicating the reference location of the measurement device.

23. The system of claim 22, wherein the depth correction computing device is configured to receive, via the communications interface, the measurement reference position.

24. (canceled).

25. The system of claim 22, wherein the measurement device is configured to provide the one or more geological measurement values to the depth correction computing device via the communications interface.

26.-36. (canceled).
